(19) United States
(12) Patent Application Publication
(10) Pub. No.: US 2009/0077980 A1
(43) Pub. Date: Mar. 26, 2009

(54) Method and system for forming beaded ice cream products

(76) Inventor: Stan Jones, Vienna, IL (US)

Correspondence Address: STOCKWELL & SMEDLEY, PSC, 861 CORPORATE DRIVE, SUITE 200, LEXINGTON, KY, 40503, US

(21) Appl. No.: 11/903,946

(22) Filed: Sep. 25, 2007

(51) Int. Cl. A23G 9/44; A23G 9/14

(52) U.S. Cl. 62/1; 62/340

(57) ABSTRACT

A system and mechanism for forming discrete units of ice cream is disclosed utilizing cryogenically cooled rotating rollers to form the ice cream units during the manufacturing process.

### FIELD OF THE INVENTION

The present invention relates to an ice cream mechanism, and more particularly to a system and mechanism for forming beaded ice cream using cryogenically cooled equipment.

### BACKGROUND OF THE INVENTION

Ice cream products are known to be popular and there are a variety of different methods for manufacturing various ice cream products that may be stored in conventional freezers as well as commercial-grade freezers which can maintain temperatures of about negative 40° F. Some of these methods utilize cryogenic equipment and techniques to form free-flowing particulate ice cream confections such as those disclosed in earlier U.S. patents. However, there is the need for alternative and efficient methods to form such confections and the need for such improvement is especially great with regards to ice-cream type food products formed using cryogenically cooled equipment.

### SUMMARY OF THE INVENTION

Aspects of the present invention relate to a method for producing particulate frozen food products. The steps of such a method include a) rotating a first and second cylindrical roller adjacent one another such that an aperture is formed along a respective major axis of each roller, each roller having a plurality of hemispherical indentations; b) providing ice cream at an opening of the aperture such that the ice cream flows through the aperture between the rollers and is forced into at least some of the indentations to form a plurality of substantially uniformly-shaped units, the rollers maintained at a temperature colder than the ice cream; and c) controlling rotation of the first and second cylindrical roller such that a pair of the plurality of indentations are formed such that one of the pair is located on the first roller and another of the pair is located on the second roller and are positioned thereon to be aligned with one another at a point of rotation where the ice cream and the pair of indentations coincide.

Another aspect of the present invention relates to an apparatus for producing frozen food products that includes a) a first and second cylindrical roller adjacent one another such that an aperture is formed along a respective major axis of each roller, each roller having a plurality of indentations and rotatable around its respective longitudinal axis; b) an ice cream feeder positioned so as to feed ice cream to the aperture to pass between the first and second cylindrical roller and be forced into at least some of the indentations to form a plurality of substantially uniformly-shaped units; c) a conveyor positioned to catch the plurality of substantially uniformly-shaped units, the conveyor being maintained at a cryogenic temperature; and d) a controller configured to control rotation of the first and second cylindrical roller such that a pair of the plurality of indentations are formed such that one of the pair is located on the first roller and another of the pair is located on the second roller and are positioned thereon to be aligned with one another at a point of rotation where the ice cream and the pair of indentations coincide.

It is understood that other embodiments of the present invention will become readily apparent to those skilled in the art from the following detailed description, wherein it is shown and described only various embodiments of the invention by way of illustration. As will be realized, the invention is capable of other and different embodiments and its several details are capable of modification in various other respects, all without departing from the spirit and scope of the present invention. Accordingly, the drawings and detailed description are to be regarded as illustrative in nature and not as restrictive.

### BRIEF DESCRIPTION OF THE DRAWINGS

FIG. 1 shows a stamping mechanism for stamping or pressing ice cream into uniform shapes or units in accordance with the principles of the present invention;

FIG. 2 shows a flowchart of the steps for operating the stamping mechanism of FIG. 1;

FIG. 3 depicts a serving of particulate products that are formed in accordance with the principles of the present invention; and

FIG. 4 depicts various generally spherical shapes that are meant to be encompassed by the term “beads” as used throughout the present description and claims.

### DETAILED DESCRIPTION OF THE PREFERRED EMBODIMENTS

The detailed description set forth below in connection with the appended drawings is intended as a description of various embodiments of the invention and is not intended to represent the only embodiments in which the invention may be practiced. The detailed description includes specific details for the purpose of providing a thorough understanding of the invention. However, it will be apparent to those skilled in the art that the invention may be practiced without these specific details. In some instances, well known structures and components are shown in block diagram form in order to avoid obscuring the concepts of the invention.

The embodiments of the present invention relate to particulate frozen food product or frozen confection, and in certain embodiments to particulate ice creams, ice milks, sorbets, and ices capable of being stored within commercial dairy freezers and storage equipment at conventional freezer temperatures. Such particulate confections that are storable at colder temperatures (e.g., −40° F.) to maintain their free-flowing characteristics are contemplated as well.

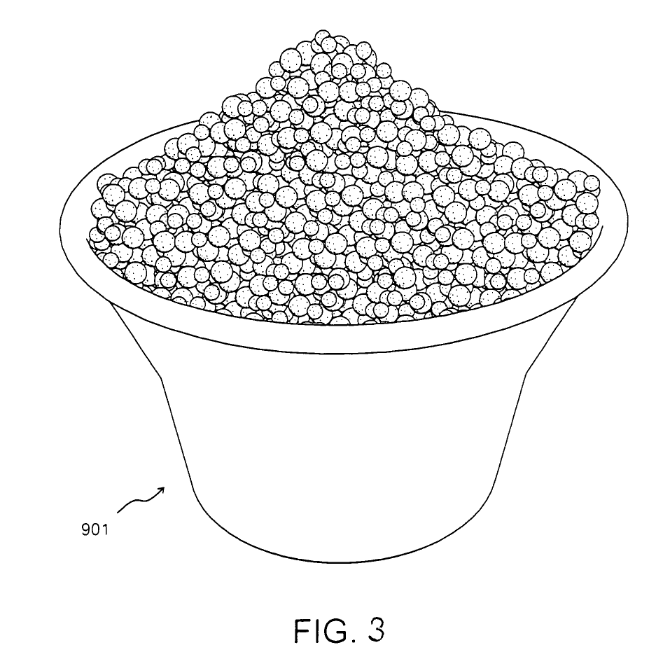

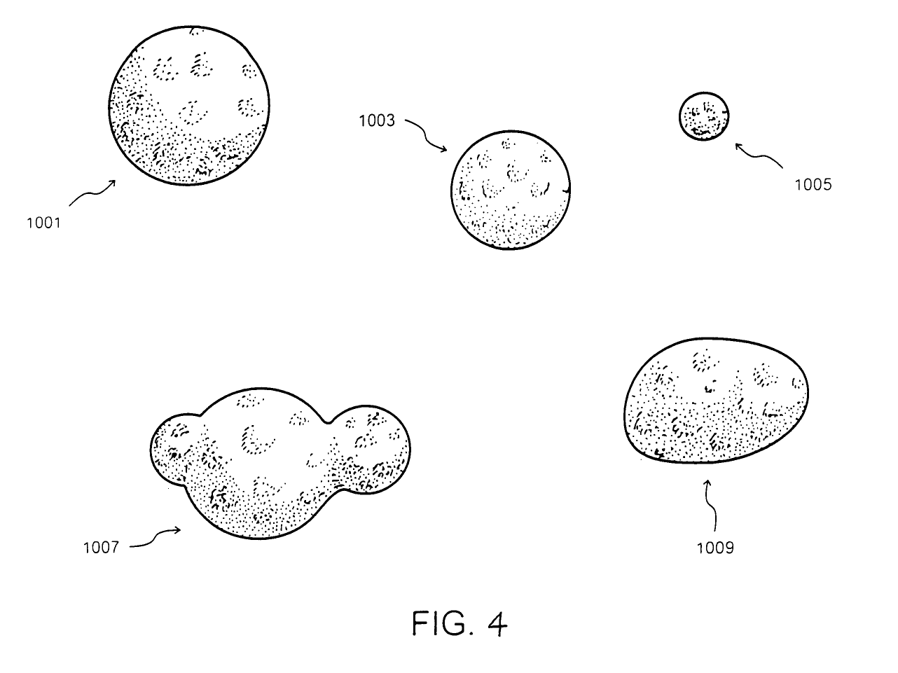

As a result of the methods described herein, there are provided formulations of frozen confections, such as ice cream, ice milk, ices, frozen yogurt, sherbet, or sorbet, in the form of small particulate shapes that remain free-flowing during storage. The particulate shapes, generally referred to as “beads”, may have a generally spherical, spheroid shape as shown in FIG. 3, but may also have an oblong, elliptical, oblate, tubular, or other slightly irregular shape as shown in FIG. 4. In addition to having an irregular overall shape, the surface of the particulate shape may also be either smooth or irregular (e.g. bumpy, pocked, etc.). On average, the particulate shapes will preferably have a diameter of about 5 mm or less but can also be larger such as between about 6 and about 10 mm. Particulate shapes having diameters outside these ranges are also contemplated. For non-spherical shapes which do not have a conventional diameter, the diameter is considered to be the diameter of the smallest sphere into which the particulate shape would fit.

It is desired that the particulate or beaded product is in a free-flowing format so that it is readily pourable. Free-flowing, as used herein, is a broad term which includes the ability of the product to flow as individual particulate shapes, with little or no clumping or sticking to each other, during such pouring. There may be slight sticking after a period of storage, but a light tap on the container will unstick the particulate shapes and allow them to be free flowing. The generally spherical shape helps contribute to the free-flowing, pourable product.

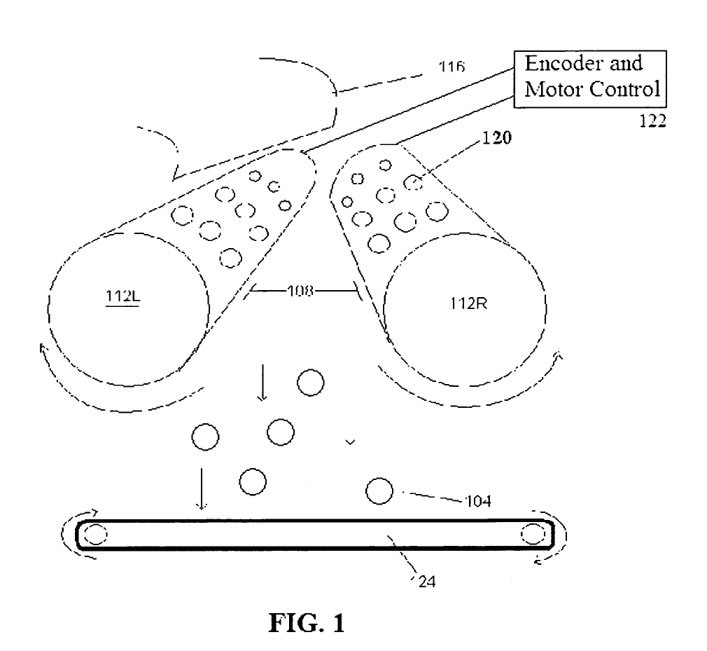

FIG. 1 shows a mechanism 100 for stamping or pressing ice cream into generally uniform shapes or units 104. The mechanism has an aperture 108 for admitting the ice cream to be processed. The rollers 112L and 112R have indentations 120 in various shapes, and one or both are maintained at cryogenic temperatures. For example, the rollers 112L, 112R may be partially hollow so that cryogenic fluid can be circulated within the roller. Also, the rollers may be formed as jacketed sleeves so that the cryogenic fluid can circulate between the two sleeves. As shown, the indentations 120 are formed on both rollers 112L, 112R. In operation a pair of indentations (one on each roller 112L, 112R) may become aligned substantially at the point where the ice cream 116 flows between the two rollers 112L, 112R. As this occurs, a plurality of pairs of the indentations form a mold into which the ice cream 116 is forced and thus shaped into the units 104. Because the indentations 120 are arranged along the entire outer surface of the rollers 112L, 112R, different pairs align with one another at multiple points of rotation.

In order to form generally spherical beads, the indentation 120 are hemispherical in shape such that the two halves align with one another to form a generally spherical unit 104. To help ensure that indentations 120 properly align with one another the rollers 112L, 112R may be geared so as to rotate in a controlled manner that ensures alignment of indentations 120. Alternatively, as shown in FIG. 1, a controller 122 may be used along with an optical encoding mechanism that monitors the rotation of the rollers 112L, 112R and controls their speed to ensure the indentations 120 align properly. One of ordinary skill will readily recognize that there are also other functionally equivalent methods of aligning the indentations that may be utilized without departing from the scope of the present invention.

Rather than a flat surface on the insides of the indentations 120, the surface may be textured so as to add a texture pattern to a surface of each of the units 104 as well. Once stamped or pressed, the units 104 are dropped by gravity onto a conveyer 124, which is also maintained at a cryogenic temperature. For example, the conveyor may be located within a trough suspended above a region where liquid nitrogen is fed. Thus, the ambient temperature near the conveyor is maintained near cryogenic temperatures. The conveyor may also be implemented as a screw and trough that is located within a cryogenically cooled environment that laterally transports the units 104 as the screw turns.

By making all the indentations 120 the same on the rollers 112L, 112R, the resulting units 104 will be substantially similar in size and shape. While this is preferable because it assists with sorting units 104 the indentations 120 may be shaped different from one another in order to produce different shaped or sized units 104 at the same time.

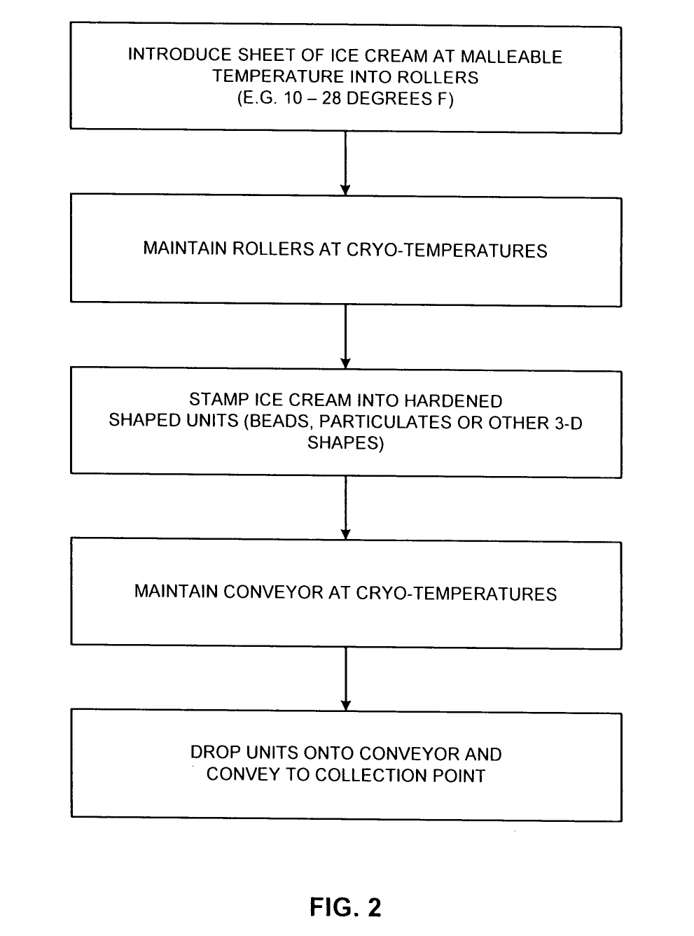

FIG. 2 shows a flowchart of the steps for operating the mechanism 100 of FIG. 1. First, ice cream is introduced at the aperture 108 in the form of a sheet 116 provided by an ice cream feeding device that can control the size of the sheet and its delivery rate. The sheet 116 extends roughly the length of the rollers 112R, 112L because the indentations 120 extend along this entire length as well. Sizing the sheet 116 in this manner ensures maximum use of all the indentations 120. The thickness of the sheet 116 depends on the desired units 104 being produced but is sufficient to ensure that the indentations 120 are uniformly and completely filled with ice cream during production. Typically, the sheet 116 can range from 5 mm to 15 mm in thickness but other thicknesses are contemplated as well. The temperature of the sheet 116 at the time it meets the aperture 108 is maintained such that the sheet 116 is still malleable and in a semi-solid form that can still be manipulated which for many ice cream products is around 28° F. but this can vary by as much as 10° F. depending on the composition of the ice cream and whether the ice cream sheet 116 is fed via gravity or via a pressurized source.

Because the rollers 112L, 112R are generally cylindrical in nature, the aperture 108 that extends along the length or major axis of each roller exists above the rollers but is almost non-existent at the point where the two rollers meet near their centers. In this way, the sheet 116 is mechanically forced into the indentations 120 through pressure exerted by the surface of the opposite roller. As they each rotate around their center or longitudinal axis (as shown by the arrows in FIG. 1), the rollers 112L and 112R come in contact with the sheet 116 and press it into the indentations 120 that are machined into the rollers 112L and 112R. As the rollers 112L, 112R continue to rotate, the units 104 fall from the indentations 120 and drop onto the conveyor 124. Beneficially, the rollers 112L, 112R rotate so their speed approximately matches that of the falling sheet 116. Because they are cryogenically cooled, the rollers 112L and 112R underneath the aperture 108 are maintained at a much lower temperature than exists at the aperture 108. For this reason, the sheet 116 is still semi-soft and therefore malleable, but the resulting units 104 are more solidified and no longer malleable and, thus, can easily fall out of the indentations 120 via gravity. The cryogenic temperatures of the conveyor 124 assist in completing the process of hardening the units 104.

The units 104 can be collected into batches from the conveyor 124 before being placed in storage containers, shipping containers, or serving containers. For example, an amount of units 104 for comfortably fitting within a container can be collected from the conveyor 124 at a terminating point or at stations along the conveyor 124.

The stamping mechanism 100 also has a “return of flash” feature. Because some of the sheet 116 will not be stamped into units 104, but instead passes through the rollers 112L and 112R without contacting the indentations 120, it is necessary to capture and recycle this raw ice cream or “flash” and any smaller pieces as well. To achieve this, the stamping mechanism 100 has a return filter which ensures that only properly formed units 104 are conveyed along conveyor 124. The filter acts to screen out objects that are too large and also objects that are too small to be properly shaped units 104. The remainder or flash is returned to the device that forms the sheets 116, where that flash gets another chance to be transformed into a unit 104.

The ice cream sheet 116 can be made from any of a wide variety of recipes. The consistency and characteristics of the resulting sheet 116 will determine the speed and pressure at which the sheet 116 should be delivered to the aperture. For example, a stiffer mixture will likely need more pressure to have a steady flow rate to the aperture while a thinner mixture may be sufficiently delivered relying only on gravity. Two co-pending patent applications filed by the present Applicant that disclose a variety of applicable ice cream recipes are application Ser. No. 11/299,921 filed Dec. 12, 2005 and application Ser. No. 11/801,049 filed May 8, 2007; the disclosures of which are hereby incorporated by reference in their entirety. Additionally, “Ice Cream, 6 ed.” by Robert T. Marshall et al. provides well known recipes for ice cream, confection ice cream, frozen yogurt, puddings, parfaits, sherbets, sorbets, and other frozen confections. Any of these recipes are considered to be examples of “ice cream” that may be used to formulate the sheet 116 that is used in the above-described process and system.

The previous description is provided to enable any person skilled in the art to practice the various embodiments described herein. Various modifications to these embodiments will be readily apparent to those skilled in the art, and the generic principles defined herein may be applied to other embodiments. Thus, the claims are not intended to be limited to the embodiments shown herein, but are to be accorded the full scope consistent with each claim's language, wherein reference to an element in the singular is not intended to mean “one and only one” unless specifically so stated, but rather “one or more.” All structural and functional equivalents to the elements of the various embodiments described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using the phrase “means for” or, in the case of a method claim, the element is recited using the phrase “step for.”

What is claimed is:

1. A method for producing particulate frozen food products comprising the steps of:
rotating a first and second cylindrical roller adjacent one another such that an aperture is formed along a respective major axis of each roller, each roller having a plurality of hemispherical indentations;
providing ice cream at an opening of the aperture such that the ice cream flows through the aperture between the rollers and is forced into at least some of the indentations to form a plurality of substantially uniformly-shaped units, the rollers maintained at a temperature colder than the ice cream; and
controlling rotation of the first and second cylindrical roller such that a pair of the plurality of indentations are formed such that one of the pair is located on the first roller and another of the pair is located on the second roller and are positioned thereon to be aligned with one another at a point of rotation where the ice cream and the pair of indentations coincide.

2. The method of claim 1, wherein at least one of the cylindrical rollers is maintained at a cryogenic temperature while rotating.

3. The method of claim 1, wherein the ice cream is provided as a sheet.

4. The method of claim 1, wherein the particulate frozen food products are substantially spherical in shape.

5. The method of claim 4, wherein the particulate frozen food product has an average diameter of about 5 mm.

6. The method of claim 1, wherein the ice cream is provided as a gravity-fed flow.

7. The method of claim 1, wherein the ice cream is provided as a pressurized flow.

8. The method of claim 1, wherein the ice cream has a temperature of between about 10° F. and about 28° F.

9. The method of claim 1, wherein the ice cream is in a semi-solid state that can flow by gravity.

10. The method of claim 1, further comprising the step of:
separating the units from any ice cream not formed into the plurality of substantially uniformly-shaped units.

11. The method of claim 1, further comprising the step of:
conveying the units using a cryogenically cooled conveyor.

12. An apparatus for producing frozen food products comprising:
a first and second cylindrical roller adjacent one another such that an aperture is formed along a respective major axis of each roller, each roller having a plurality of indentations and rotatable around its respective longitudinal axis;
an ice cream feeder positioned so as to feed ice cream to the aperture to pass between the first and second cylindrical roller and be forced into at least some of the indentations to form a plurality of substantially uniformly-shaped units;
a conveyor positioned to catch the plurality of substantially uniformly-shaped units, the conveyor being maintained at a cryogenic temperature;
a controller configured to control rotation of the first and second cylindrical roller such that a pair of the plurality of indentations are formed such that one of the pair is located on the first roller and another of the pair is located on the second roller and are positioned thereon to be aligned with one another at a point of rotation where the ice cream and the pair of indentations coincide.

13. The apparatus of claim 12, wherein at least one of the first and second cylindrical roller is maintained at a cryogenic temperature.

14. The apparatus of claim 12, wherein the ice cream is formed as a sheet when being fed to the aperture.

15. The apparatus of claim 12, wherein the ice cream is in a semi-solid state that can flow by gravity when being fed to the aperture.

16. A frozen food product manufactured by:
rotating a first and second cylindrical roller adjacent one another such that an aperture is formed along a respective major axis of each roller, each roller having a plurality of hemispherical indentations;
providing ice cream at an opening of the aperture such that the ice cream flows through the aperture between the rollers and is forced into at least some of the indentations to form a plurality of substantially uniformly-shaped units, the rollers maintained at a temperature colder than the ice cream; and
controlling rotation of the first and second cylindrical roller such that a pair of the plurality of indentations are formed such that one of the pair is located on the first roller and another of the pair is located on the second roller and are positioned thereon to be aligned with one another at a point of rotation where the ice cream and the pair of indentations coincide.

17. The product of claim 16, wherein the product remains free-flowing when stored at about 0° F.

18. The product of claim 16, wherein the product remains free-flowing when stored at about negative 40° F.

19. The product of claim 16, wherein the units have an average diameter of about 5 mm.

20. The product of claim 16, wherein the units are substantially spherical in shape.
